(19) United States
(12) Patent Application Publication
(10) Pub. No.: US 2011/0216065 A1
(43) Pub. Date: Sep. 8, 2011

(54) Method and System for Rendering Multi-View Image

(75) Inventors: Kai-Che Liu, Kaohsiung City (TW); Wei-Jia Huang, Puli Township (TW); Wei-Hao Huang, Tainan City (TW)

(73) Assignee: Industrial Technology Research Institute, Hsinchu (TW)

(21) Appl. No.: 13/110,105

(22) Filed: May 18, 2011

Related U.S. Application Data
(63) Continuation-in-part of application No. 12/752,600, filed on Apr. 1, 2010.

(30) Foreign Application Priority Data
Dec. 31, 2009 (TW) 98146266
Dec. 24, 2010 (TW) 99145933

(51) Int. Cl. G06T 11/00

(52) U.S. Cl. 345/428

(57) ABSTRACT

A method and a system for rendering a multi-view image are provided. The method for rendering a multi-view image executed by a computer includes the following steps. A plurality of single-view images whose view-angles are different from each other are provided using the computer. A resolution resizing process is performed using the computer on the single-view images to obtain at least a portion of the pixels of a plurality of new-resolution images. A view interlace process is performed using the computer on the at least a portion of the pixels of the new-resolution images to result in a multi-view image.

This application claims the benefit of Taiwan application Serial No. 99145933, filed Dec. 24, 2010. This application is also a continuation-in-part application of U.S. application Ser. No. 12/752,600, filed Apr. 1, 2010, which claims the benefit of Taiwan application Serial No. 98146266, filed Dec. 31, 2009. The subject matter of these applications is incorporated herein by reference.

### BACKGROUND

1. Technical Field

The disclosure relates in general to a method and a system for rendering an image, and more particularly to a method and a system for rendering a multi-view image.

2. Description of the Related Art

Digital images having the advantages of saving films, space, not fading, and being easy to store and edit and good portability have gradually replaced the photos taken with conventional films.

Along with the development in digital image technology, various image editing technologies are continuously provided. With the assistance of image editing technology, interesting patterns can be added to the photos so that the photos can be prettified or even edited into a multi-view 3D image.

However, the method for rendering a multi-view 3D image is very complicated. In terms of processing technology, the processing speed must be effectively increased for the multi-view 3D image to greater popularity.

### SUMMARY

According to an aspect of the disclosure, a method for rendering a multi-view image is provided. The method for rendering a multi-view image includes the following steps. A plurality of single-view images whose view-angles are different from each other are provided using a computer. A resolution resizing process is performed on the single-view images using the computer to obtain at least a portion of the pixels of a plurality of new-resolution images. A view interlace process is performed on the at least a portion of the pixels of the new-resolution images using the computer to result in a multi-view image.

According to another aspect of the disclosure, a system for rendering a multi-view image is provided. The system for rendering a multi-view image includes a providing unit and a processing unit. The providing unit provides a plurality of single-view images whose view-angles are different from each other. The processing unit performs a resolution resizing process on the single-view images to obtain at least a portion of the pixels of a plurality of new-resolution images, and performs a view interlace process on the at least a portion of the pixels of the new-resolution images to result in a multi-view image.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a system for rendering a multi-view image according to a first embodiment;

FIG. 2 shows a flowchart of a method for rendering a multi-view image according to a first embodiment;

FIG. 3 shows a process of rendering a multi-view image according to a first embodiment;

FIG. 4 shows a process of rendering a multi-view image according to another embodiment;

FIG. 5 shows a system for rendering a multi-view image according to a second embodiment;

FIG. 6 shows a flowchart of a method for rendering a multi-view image according to a second embodiment;

FIG. 7 shows a process of rendering a multi-view image according to a second embodiment;

FIG. 8 shows a system for rendering a multi-view image according to a third embodiment;

FIG. 9 shows a flowchart of a method for rendering a multi-view image according to a third embodiment;

FIG. 10 shows a process of rendering a multi-view image according to a third embodiment.

### DETAILED DESCRIPTION

The disclosure is elaborated in a number of embodiments below. However, the embodiments are for elaboration purpose only, not for limiting the scope of protection of the disclosure. Moreover, secondary elements are omitted in the accompanying drawings of the embodiments to highlight the technical features of the disclosure.

### First Embodiment

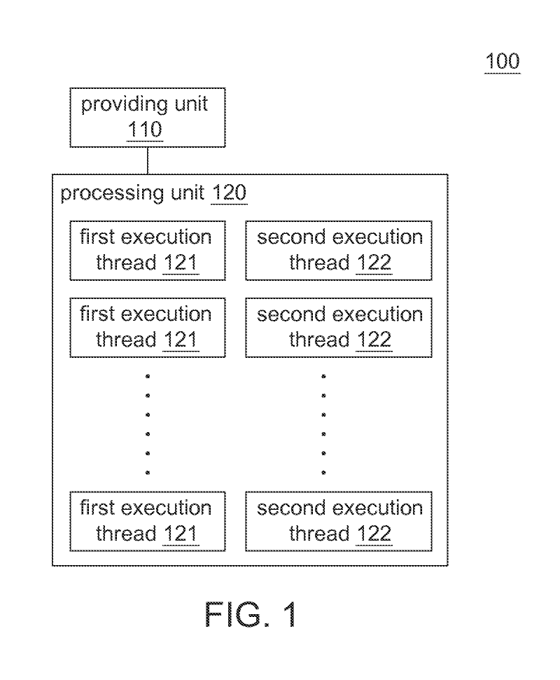

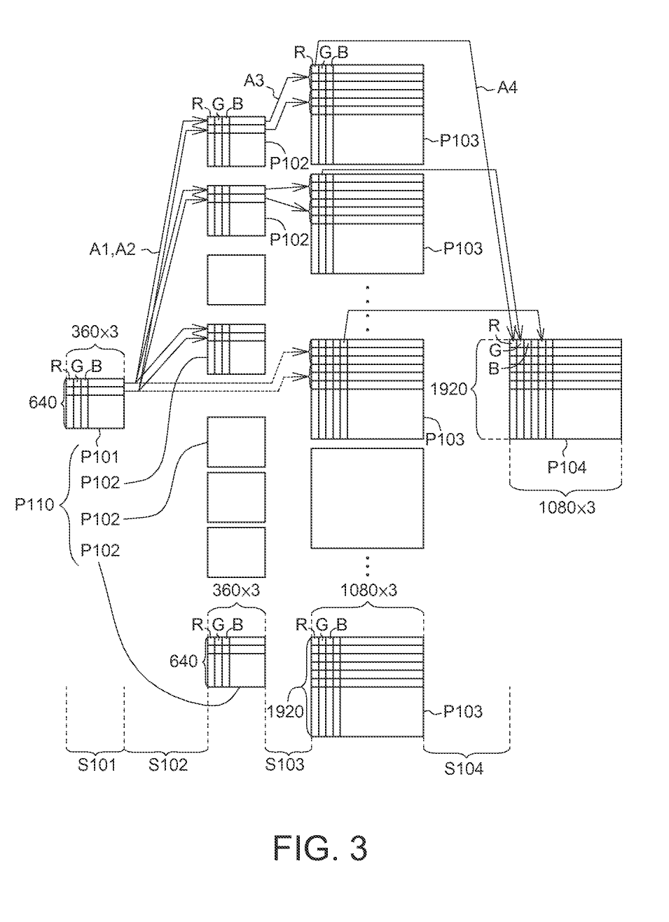

Referring to FIG. 1, a system 100 for rendering a multi-view image P104 (illustrated in FIG. 3) according to a first embodiment is shown. The system 100 for rendering a multi-view image includes a providing unit 110 and a processing unit 120. The providing unit 110 provides various types of information and can be realized by such as a camera, a storage medium and a connection port for connecting the storage medium. The processing unit 120 executes various processes and computation procedures, and can be realized by such as a central processing unit (CPU), a graphic processing unit (GPU), a firmware circuit and a storage medium storing several programming codes. The processing unit 120 of the present embodiment of the disclosure includes a plurality of first execution threads 121 and a plurality of second execution threads 122. The first execution threads 121 perform various processes and computation procedures by way of parallel processing, and the second execution threads 122 also perform various processes and computation procedures by way of parallel processing.

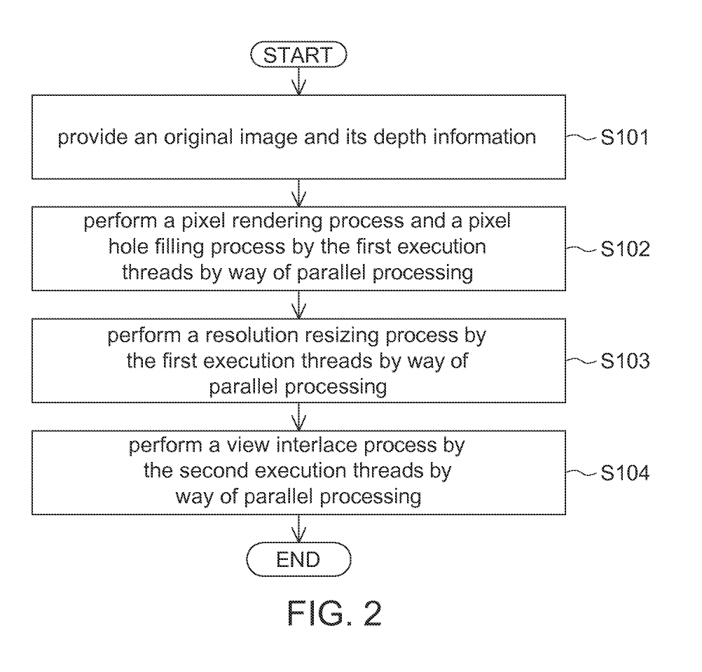

Referring to FIGS. 2 to 3. FIG. 2 shows a flowchart of a method for rendering a multi-view image P104 according to a first embodiment. FIG. 3 shows a process of rendering a multi-view image P104 according to a first embodiment. The operations of the system 100 for rendering a multi-view image P104 and the method for rendering a multi-view image P104 according to the present embodiment of the disclosure are elaborated below with a flowchart and a schematic diagram. However, anyone who is skilled in the technology of the disclosure will understand that the system 100 for rendering a multi-view image P104 according to the present embodiment of the disclosure is not limited to the procedures and sequence illustrated in FIG. 2, and the method for rendering a multi-view image P104 illustrated in FIG. 2 is not limited to be used in the system 100 for rendering a multi-view image P104 illustrated in FIG. 1.

Firstly, the method begins at step S101, an original image P101 and its depth information are provided by the providing unit 110 using a computer. Let FIG. 3 be taken for example. The original image P101 has 640 rows, 360 columns, and 3 color channels 3 (for example, “R” denotes red, “G” denotes green, “B” denotes blue), and the resolution level equals 640×360×3.

Next, the method proceeds to step S102, a pixel rendering process Al and a pixel hole filling process A2 are performed using the computer on the original image P101 by the first execution threads 121 of the processing unit 120 according to the depth information by way of parallel processing to result in a plurality of new view-angle images P102. Let FIG. 3 be taken for example. After the pixel rendering process A1 and the pixel hole filling process A2 are performed on the original image P101, eight new view-angle images P102 are resulted, wherein each new view-angle image P102 has 640 rows, 360 columns, and 3 color channels 3 (for example, “R” denotes red, “G” denotes green, “B” denotes blue), and the resolution level equals 640×360×3.

In the pixel rendering process A1, each pixel of the original image P101 is translated to an appropriate position so as to render eight new view-angle images P102. The pixel hole filling process A2 is performed to fill the hole which occurs to the new view-angle images P102 in the course of pixel translation.

Let FIG. 3 be taken for example. The single-view image P110 is composed of one original image P101 and eight new view-angle images P102, and thus has nine images in total. The view-angles of the images of the single-view image P110 are different from each other but their resolution levels are the same, that is, 640×360×3. Thus, a plurality of single-view images P110 are obtained through steps S101 to S102.

Then, the method proceeds to step S103, a resolution resizing process A3 is performed using the computer on the single-view images P110 by the first execution threads 121 by way of parallel processing to obtain a plurality of new-resolution images P103. Let FIG. 3 be taken for example.

The resolution levels of the nine single-view image P110 all equal 640×360×3, and each new-resolution image P103 has 1920 rows, 1080 columns, and 3 color channels, and the resolution level equals 1920×1080×3.

In the present embodiment of the disclosure, the pixel rendering process A1, the pixel hole filling process A2 and the resolution resizing process A3 are all performed by the first execution threads 121 by way of parallel processing. Let FIG. 3 be taken for example. The arrows between the original image P101 and the new view-angle images P102 indicate that each first execution thread 121 executes the step S102 of performing the pixel rendering process A1 and the pixel hole filling process A2, so the number of the first execution threads 121 equals the product of the number of the rows of the new view-angle images P102 multiplied by the number of the new view-angle images P102 (that is, 640×8).

Moreover, the arrows between the new view-angle images P102 and the new-resolution images P103 indicate that each first execution thread 121 executes the step S103 of performing the resolution resizing process A3, so the number of the first execution threads 121 also equals the product of the number of the rows of each new view-angle image P102 multiplied by the number of the new view-angle images P102 (that is, 640×8).

In addition, the arrows between the original image P101 and the new-resolution images P103 indicate the operation of another resolution resizing process A3, which can be executed synchronically by another processing unit (CPU).

After that, the method proceeds to step S104, a view interlace process A4 is performed using the computer on the pixels of the new-resolution images P103 by the second execution threads 122 by way of parallel processing to result in a multi-view image P104. Let FIG. 3 be taken for example. The resolution level of the new-resolution images P103 is the same with that of the multi-view image P104 to be resulted (that is, 1920×1080×3), so pixels at the corresponding positions of the new-resolution images P103 are selected by the second execution threads 122 to result in a multi-view image P104 (the pixels that are not selected are eliminated).

As indicated in FIG. 3, the arrows between the new-resolution images P103 and the multi-view image P104 indicates the operation of step S104 of performing a view interlace process A4. Thus, the number of the second execution threads 122 equals the product of the number of the rows of the multi-view image P104 multiplied by the number of the columns of the multi-view image P104 and by the number of color channels (that is, 1920×1080×3).

As indicated in FIG. 3, the resolution resizing process A3 is performed on all of the pixels composing the multi-view image P104, so each pixel of the multi-view image P104 is obtained by performing floating point operation on a plurality of adjacent pixels of the single-view image P103. Thus, each pixel of the multi-view image P104 can precisely represent the content that should be represented at the position.

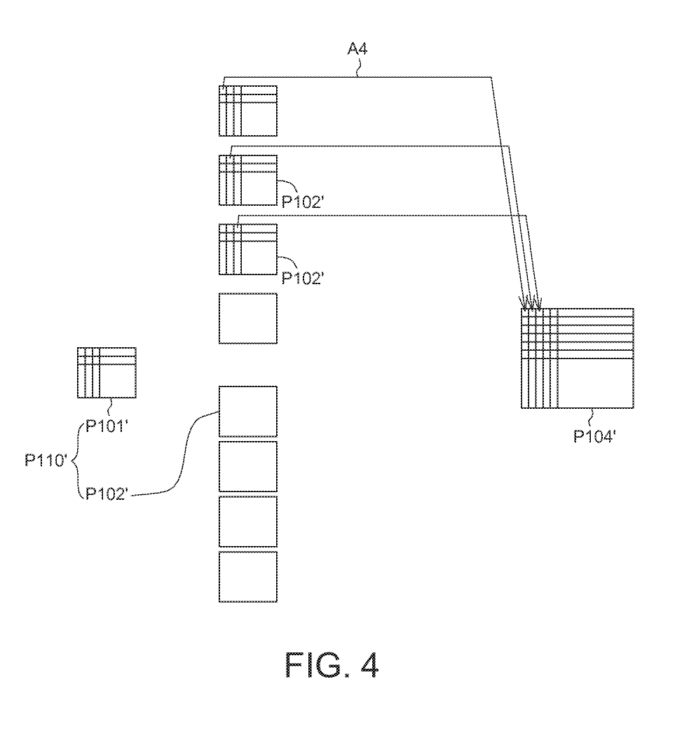

Referring to FIG. 4, a process of rendering a multi-view image P104′ according to another embodiment is shown. Let FIG. 4 be taken for example. After the pixel rendering process A1 and the pixel hole filling process A2 are performed on the original image P101 to result in a plurality of new view-angle images P102′, the original image P101′ and the new view-angle image P102′ compose a plurality of single-view images P110′. Then, the view interlace process A4 is performed on the single-view images P110′ directly to obtain a multi-view image P104′ without going through the resolution resizing process A3. Since the pixels for composing the multi-view image P104′ do not go through the resolution resizing process A3, each pixel of the multi-view image P104′ is directly selected from the pixels of the single-view image P110′. Thus, each pixel of the multi-view image P104′ cannot precisely represent the content that should be represented at the position, and jaggy lines will occur to the frame.

To the contrary, each pixel of the multi-view image P104 of FIG. 3 is obtained by performing floating point operation on a plurality of adjacent pixels of the single-view image P103, so each pixel of the multi-view image P104 can precisely represent the content that should be represented at the position, hence largely reducing the occurrence of jaggy lines on the frame.

### Second Embodiment

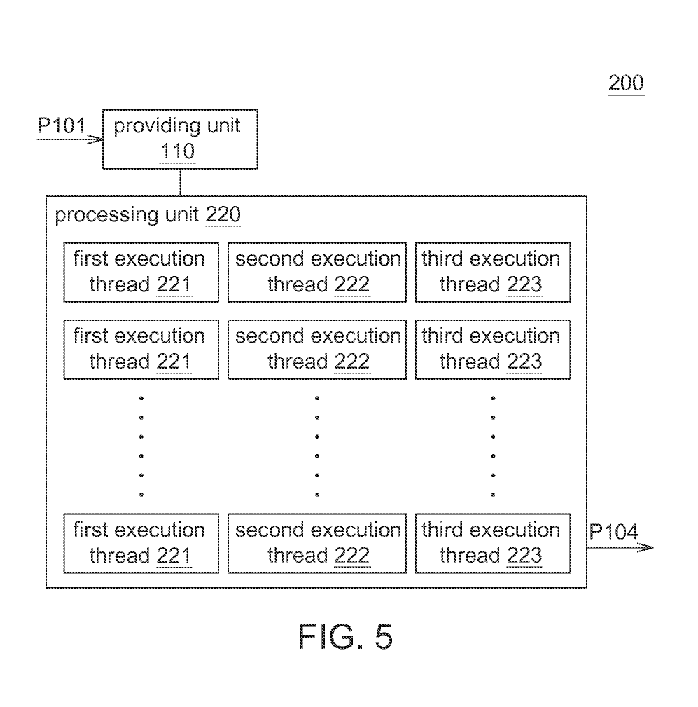

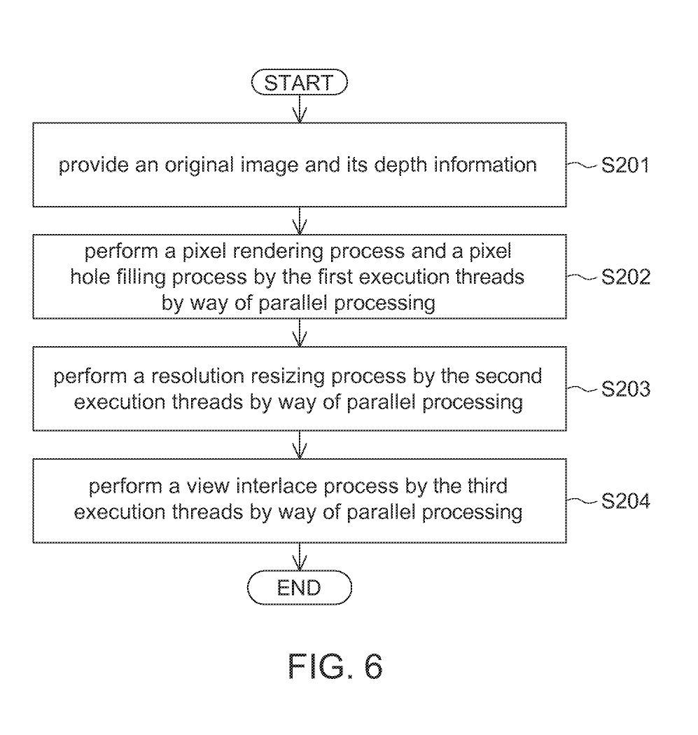

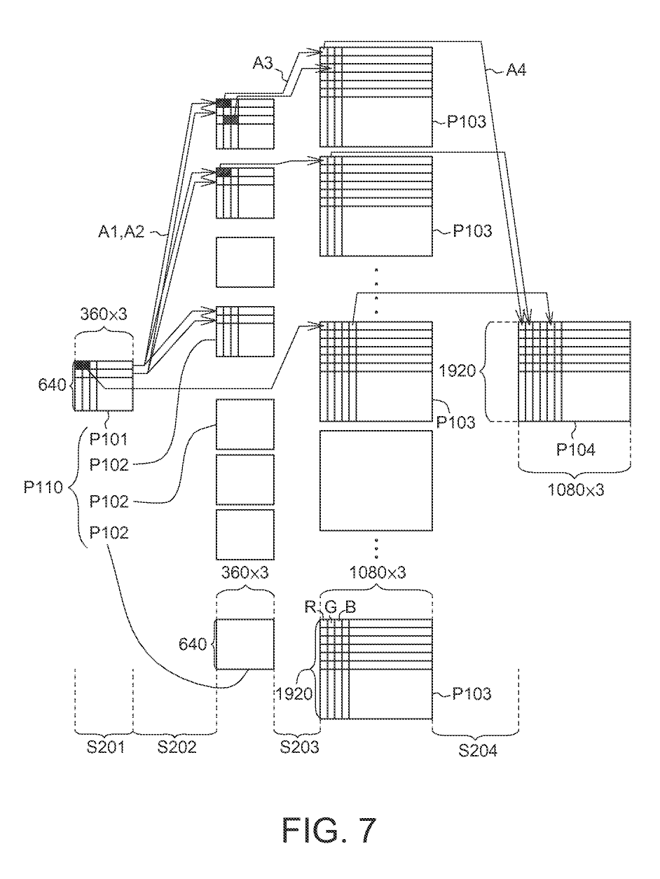

Referring to FIGS. 5 to 7. FIG. 5 shows a system 200 for rendering a multi-view image P104 according to a second embodiment. FIG. 6 shows a flowchart of a method for rendering a multi-view image P104 according to a second embodiment. FIG. 7 shows a process of rendering a multi-view image P104 according to a second embodiment. The system 200 and method for rendering a multi-view image P104 of the present embodiment of the disclosure are different from the system 100 and method for rendering a multi-view image P104 of the first embodiment in the arrangement of the execution threads, and the similarities are not repeated here.

As indicated in FIG. 5, the processing unit 220 of the present embodiment of the disclosure includes a plurality of first execution threads 221, a plurality of second execution threads 222 and a plurality of third execution threads 223. The first execution threads 221 execute the pixel rendering process A1 and the pixel hole filling process A2. The second execution threads 222 execute the resolution resizing process A3. The third execution threads 223 execute the view interlace process A4.

The method for rendering a multi-view image P104 according to the present embodiment of the disclosure is elaborated below with FIGS. 6 and 7. Firstly, the method begins at step S201, an original image P101 and its depth information is provided by a providing unit 110 using a computer.

Next, the method proceeds to step S202, a pixel rendering process A1 and a pixel hole filling process A2 are performed using the computer on the original image P101 by the first execution threads 221 of the processing unit 220 according to the depth information by way of parallel processing to result in a plurality of new view-angle image P102.

In the present embodiment of the disclosure, the pixel rendering process A1 and the pixel hole filling process A2 are both performed by the first execution threads 221 by way of parallel processing. Let FIG. 7 be taken for example. The arrows between the original image P101 and the new view-angle images P102 indicate that each first execution thread 221 executes the step S202 of performing the pixel rendering process A1 and the pixel hole filling process A2, so the number of the first execution threads 221 equals the product of the number of the rows of the new view-angle image P102 multiplied by the number of the new view-angle images P102 (that is, 640×8).

Then, the method proceeds to step S203, a resolution resizing process A3 is performed using the computer on the single-view images P102 by the second execution threads 222 by way of parallel processing to obtain a plurality of new-resolution images P103.

In the present embodiment of the disclosure, resolution resizing process A3 are executed by the second execution threads 222 by way of parallel processing. Let FIG. 7 be taken for example. The arrows between the single-view image P110 (including the original image P101 and the new view-angle images P102) and the new-resolution images P103 indicate that each second execution thread 222 performs the resolution resizing process A3, so the number of the second execution threads 222 equals the product of the number of the rows of each new-resolution image P103 multiplied by the number of the columns of each new-resolution image P103 by the number of color channels and by the number of pieces of the new-resolution images P103 (that is, 1920×1080×3×9).

After that, the method proceeds to step S204, a view interlace process A4 is performed using the computer on the pixels of the new-resolution images P103 by the third execution threads 223 by way of parallel processing to result in the multi-view image P104. Let FIG. 7 be taken for example. The resolution level of the new-resolution images P103 is the same with that of the multi-view image P104 to be resulted, so pixels at the corresponding positions of the new-resolution images P103 are selected by the third execution threads 223 to result in a multi-view image P104.

As indicated in FIG. 7, the arrows between the new-resolution images P103 and the multi-view image P104 indicate the operation of performing the view interlace process A4. Thus, the number of the third execution threads 223 equals the product of the number of the rows of the multi-view image P104 multiplied by the number of the columns of the multi-view image P104 and by the number of color channels (that is, 1920×1080×3).

### Third Embodiment

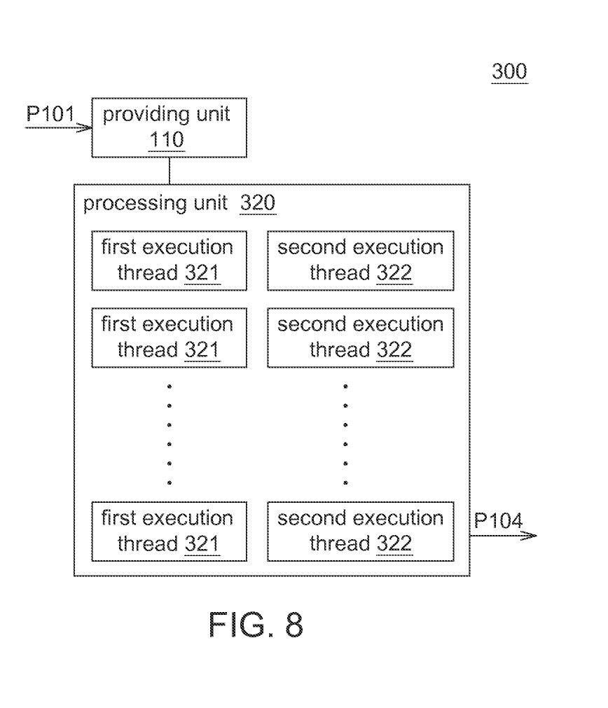

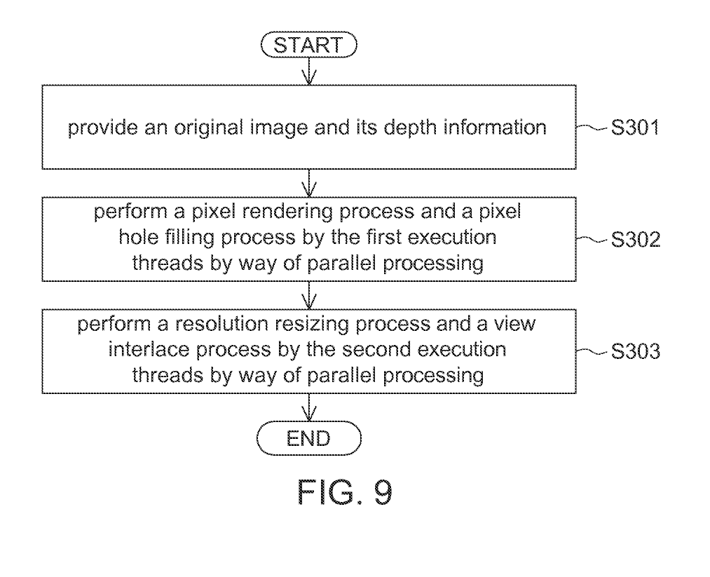

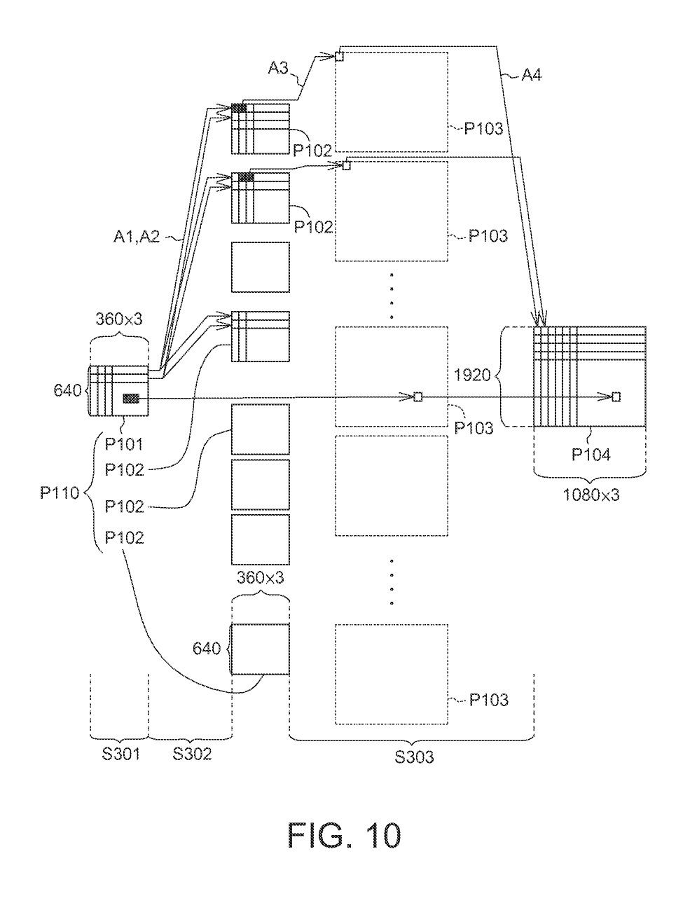

Referring to FIGS. 8 to 10. FIG. 8 shows a system 300 for rendering a multi-view image P104 according to a third embodiment. FIG. 9 shows a flowchart of a method for rendering a multi-view image P104 according to a third embodiment. FIG. 10 shows a process of rendering a multi-view image P104 according to a third embodiment. The system 300 and the method for rendering a multi-view image P104 of the present embodiment of the disclosure are different from the system 100 and the method for rendering a multi-view image P104 of the first embodiment in the arrangement of the execution threads, and the similarities are not repeated here.

As indicated in FIG. 8, the processing unit 320 of the present embodiment of the disclosure includes a plurality of first execution threads 321 and a plurality of second execution threads 322. The first execution threads 321 execute the pixel rendering process A1 and the pixel hole filling process A2. The second execution threads 322 execute the resolution resizing process A3 and the view interlace process A4.

The method for rendering a multi-view image P104 according to the present embodiment of the disclosure is elaborated below with FIGS. 9 and 10. Firstly, the method begins at step S301, an original image P101 and its depth information is provided by a providing unit 110 using a computer.

Next, the method proceeds to step S302, a pixel rendering process A1 and a pixel hole filling process A2 are performed using the computer on the original image P101 by the first execution threads 321 of the processing unit 320 according to the depth information by way of parallel processing to result in new view-angle image P102.

In the present embodiment of the disclosure, the pixel rendering process A1 and the pixel hole filling process A2 are both performed by the first execution threads 321 by way of parallel processing. Let FIG. 10 be taken for example. The arrows between the original image P101 and the new view-angle image P102 indicate that each first execution thread 321 executes the step S302 of performing the pixel rendering process Al and the pixel hole filling process A2, so the number of the first execution threads 321 equals the product of the number of the rows of the new view-angle image P102 multiplied by the number of the new view-angle images P102 (that is, 640×8).

Then, the method proceeds to step S303, a resolution resizing process A3 and a view interlace process A4 are performed using the computer on the single-view images P110 by the second execution threads 322 by way of parallel processing to obtain a plurality of multi-view images P104.

In the present embodiment of the disclosure, the second execution threads 322 only perform the resolution resizing process A3 on a portion of the pixels of the single-view image P110 but do not complete any new-resolution images P103, so the dummy new-resolution images P103 are denoted by dotted lines in FIG. 10. The dummy new-resolution images P103 are not complete, and only a portion of pixels are completed. After the pixels are completed, the pixels are inserted into the multi-view image P104 by a view interlace process A4. The arrows between the single-view image P110 (including the original image P101 and the new view-angle image P102) and the multi-view image P104 indicate that each second execution thread 322 executes the step S303 of performing the resolution resizing process A3 and the view interlace process A4. Thus, the number of the second execution threads 322 equals the product of the number of the rows of the multi-view image P104 multiplied by the number of the columns of the multi-view image P104 and by the number of color channels (that is, 1920×1080×3).

The single-view image P110 of the above embodiments is composed by the new view-angle image P102 resulted by the original image P101 going through the pixel rendering process Al and the pixel hole filling process A2. However, in other embodiments, the single-view image P110 can be shot by the camera from different view-angles without going through the pixel rendering process Al and the pixel hole filling process A2.

The above embodiment are related to a method and a system for rendering a multi-view image for increasing the speed of processing the multi-view image by way of parallel processing and for improving the quality of the multi-view image by the resolution resizing process.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method executed by a computer for rendering a multi-view image, comprising:
providing a plurality of single-view images whose view-angles are different from each other using the computer;
performing a resolution resizing process on the single-view images using the computer to obtain at least a portion of the pixels of a plurality of new-resolution images; and
performing a view interlace process on the at least a portion of the pixels of the new-resolution images using the computer to result in a multi-view image.

2. The method for rendering a multi-view image according to claim 1, wherein the single-view images comprise an original image and a plurality of new view-angle images corresponding to the original image, and the step of providing the single-view images comprises:
providing the original image and its depth information; and
performing a pixel rendering process and a pixel hole filling process on the original image according to the depth information to obtain the new view-angle images.

3. The method for rendering a multi-view image according to claim 2, wherein the pixel rendering process, the pixel hole filling process and the resolution resizing process are executed by a plurality of first execution threads by way of parallel processing, and the view interlace process is executed by a plurality of second execution threads by way of parallel processing.

4. The method for rendering a multi-view image according to claim 3, wherein the number of the first execution threads equals the product of the number of the rows of one of the new view-angle images multiplied by the number of the new view-angle images, and the number of the second execution threads equals the product of the number of the rows of the multi-view image multiplied by the number of the columns of the multi-view image and by the number of color channels.

5. The method for rendering a multi-view image according to claim 2, wherein the pixel rendering process and the pixel hole filling process are executed by a plurality of first execution threads by way of parallel processing, the resolution resizing process is executed by a plurality of second execution threads by way of parallel processing, and the view interlace process is executed by a plurality of third execution threads by way of parallel processing.

6. The method for rendering a multi-view image according to claim 5, wherein the number of the first execution threads equals the product of the number of the rows of the original image multiplied by the number of the new view-angle images, the number of the second execution threads equals the product of the number of the rows of each new-resolution image multiplied by the number of the columns of each new-resolution image, by the number of color channels and by the number of the new-resolution images, and the number of the third execution threads equals the product of the number of the rows of the multi-view image multiplied by the number of the columns of the multi-view image and by the number of color channels.

7. The method for rendering a multi-view image according to claim 2, wherein the pixel rendering process and the pixel hole filling process are executed by a plurality of first execution threads by way of parallel processing, and the resolution resizing process and the view interlace process are executed by a plurality of second execution threads by way of parallel processing.

8. The method for rendering a multi-view image according to claim 7, wherein the second execution threads perform the resolution resizing process and the view interlace process in the same step.

9. The method for rendering a multi-view image according to claim 7, wherein the number of the first execution threads equals the product of the number of the rows of the original image multiplied by the number of the new view-angle images, and the number of the second execution threads equals the product of the number of the rows of the multi-view image multiplied by the number of the columns of the multi-view image and by the number of color channels.

10. A system for rendering a multi-view image, comprising:
a providing unit for providing a plurality of single-view images whose view-angles are different from each other; and
a processing unit for performing a resolution resizing process on the single-view images to obtain at least a portion of the pixels of a plurality of new-resolution images, and performing a view interlace process on the at least a portion of the pixels of the new-resolution images to result in a multi-view image.

11. The system for rendering a multi-view image according to claim 10, wherein the single-view images comprises an original image and a plurality of new view-angle images corresponding to the original image, and the processing unit performs a pixel rendering process and a pixel hole filling process on the original image according to the depth information of the original image to obtain the new view-angle images.

12. The system for rendering a multi-view image according to claim 11, wherein the processing unit comprises:
a plurality of first execution threads for performing the pixel rendering process, the pixel hole filling process and the resolution resizing process by way of parallel processing; and
a plurality of second execution threads for performing the view interlace process by way of parallel processing.

13. The system for rendering a multi-view image according to claim 12, wherein the number of the first execution threads equals the product of the number of the rows of one of the new view-angle images multiplied by the number of the new view-angle images, and the number of the second execution threads equals the product of the number of the rows of the multi-view image multiplied by the number of the columns of the multi-view image and by the number of color channels.

14. The system for rendering a multi-view image according to claim 11, wherein the processing unit comprises:
a plurality of first execution threads for performing the pixel rendering process and the pixel hole filling process by way of parallel processing;
a plurality of second execution threads for performing the resolution resizing process by way of parallel processing; and
a plurality of third execution threads for performing the view interlace process by way of parallel processing.

15. The system for rendering a multi-view image according to claim 14, wherein the number of the first execution threads equals the product of the number of the rows of one of the new view-angle images multiplied by the number of the new view-angle images, the number of the second execution threads equals the product of the number of the rows of each new-resolution image multiplied by the number of the columns of each new-resolution image by the number of color channels and by the number of the new-resolution images, and the number of the third execution threads equals the product of the number of the rows of the multi-view image multiplied by the number of the columns of the multi-view image and by the number of color channels.

16. The system for rendering a multi-view image according to claim 11, wherein the processing unit comprises:
a plurality of first execution threads for performing the pixel rendering process and the pixel hole filling process by way of parallel processing; and
a plurality of second execution threads for performing the resolution resizing process and the view interlace process by way of parallel processing.

17. The system for rendering a multi-view image according to claim 16, wherein the second execution threads perform the resolution resizing process and the view interlace process in the same step.

18. The system for rendering a multi-view image according to claim 16, wherein the number of the first execution threads equals the product of the number of the rows of one of the new view-angle images multiplied by the number of the new view-angle images, the number of the second execution threads equals the product of the number of the rows of the multi-view image multiplied by the number of the columns of the multi-view image and by the number of color channels.
